(19) United States
(12) Patent Application Publication
(10) Pub. No.: US 2016/0293936 A1
(43) Pub. Date: Oct. 6, 2016

(54) NON-AQUEOUS ELECTROLYTE SECONDARY BATTERY

(71) Applicant: TOYOTA JIDOSHA KABUSHIKI KAISHA, Toyota-shi, Aichi-ken (JP)

(72) Inventor: Yoshitomo TAKEBAYASHI, Toyota-shi, Aichi-ken (JP)

(73) Assignee: TOYOTA JIDOSHA KABUSHIKI KAISHA, Toyota-shi, Aichi-ken (JP)

(21) Appl. No.: 15/037,207

(22) PCT Filed: Nov. 18, 2014
(86) PCT No.: PCT/IB2014/002465

§ 371 Date: May 17, 2016

(30) Foreign Application Priority Data
Nov. 22, 2013 (JP) 2013-241561

(51) Int. Cl. H01M 4/136; H01M 4/58; H01M 4/525; H01M 4/505; H01M 10/0525; H01M 4/131

(52) U.S. Cl. CPC H01M 4/136; H01M 10/0525; H01M 4/131; H01M 4/525; H01M 4/505; H01M 4/5825; H01M 2004/028

(57) ABSTRACT

The present invention provides a non-aqueous electrolyte secondary battery including a positive electrode, a negative electrode and a non-aqueous electrolyte. The working upper limit potential of the positive electrode is 4.3 V or more with metal lithium as reference. In addition, the positive electrode includes a positive electrode active material layer including a positive electrode active material, an electrically-conductive material having a DBP oil absorption of above 150 ml/100 g, and an inorganic phosphoric acid compound having an ion conductivity.

### BACKGROUND OF THE INVENTION

1. Field of the Invention

The invention relates to a non-aqueous electrolyte secondary battery. More specifically, it relates to a battery with a working upper limit potential of the positive electrode being set to 4.3 V or more (vs. Li/Li⁺).

2. Description of Related Art

The non-aqueous electrolyte, secondary battery such as lithium-ion secondary battery and nickel hydrogen battery is used as a so-called portable power supply such as a personal computer, a portable terminal and the like and a vehicle driving power supply. In particular, a lithium-ion secondary battery which is small, light and capable of obtaining, high energy density can be fairly used as a high output power supply for driving of an electrical vehicle and a hybrid vehicle.

The positive electrode of such a non-aqueous electrolyte secondary battery typically possesses a positive electrode active material layer including a positive electrode active material, a binder and an electrically-conductive material. The electrically-conductive material may function to reduce the electrical resistance within the positive electrode active material layer. Nevertheless, if the electrically-conductive material is excessively used, the proportion of the positive active material will be reduced, which may result in a concern on the declination of the energy density. As a technique related therewith, Japanese Patent Application Publication No. 2008-181714 (JP 2008-181714A), serves as an example. It is disclosed in JP 2008-181714A that by employing a carbon black having a DBP oil absorption of 250˜300 cm³/100 g as the electrically-conductive material, the content of the usage amount of the carbon black can be reduced.

However, in a non-aqueous electrolyte secondary battery, a higher energy density, as a part of the performance improvement, has always been researched and discussed. Such a high energy density can be achieved by setting the working potential of the positive electrode to higher than ever. However, in a battery using the electrically-conductive material having a high DBP oil absorption as disclosed in JP 2008-181714A, a significant declination of the battery durability exists in the case of setting the working upper limit potential of the positive electrode to higher than that of a normal non-aqueous electrolyte secondary battery, for instance, setting it to 4.3 V or more with metal lithium as reference. For instance, for a battery in a manner of repetitively high-rate charging and discharging (specifically, the vehicle-mounted battery, etc.), both the reduction of the electrical resistance and high durability of the battery become particularly important topics.

### SUMMARY OF THE INVENTION

The present invention provides a non-aqueous electrolyte secondary. battery with high energy density, whose working upper limit potential of the positive electrode is set to 4.3 V or more with metal lithium as reference, which possesses both excellent input-output characteristics and high durability.

In case of setting the working upper limit potential of the positive electrode to higher than ever, acid (e.g. hydrofluoric acid) may be produced due to the oxygenolysis of the non-aqueous electrolyte (e.g., supporting electrolyte) under an influence of becoming a high potential state of the positive electrode. Consequently, the metal elements comprised in the positive electrode active material (typically a lithium-transition metal composite oxide) may gradually dissolve into the non-aqueous electrolyte. According to the research of the inventor, it is known that in the case of the positive electrode active material layer comprises the electrically-conductive material having high DBP oil absorption (i.e. having high affinity with the non-aqueous, electrolyte), the oxygenolysis of the non-aqueous electrolyte on the surface of electrically-conductive material is promoted and the durability of the battery significantly declines. Therefore, the inventor is considering moderating the concentration of the acid in the non-aqueous electrolyte through consuming (or capturing) the generated acid. Moreover, through repetitive attentive research and discuss, a solution is found for resolving the above issue and the present invention is thereby achieved. Namely, the present invention relates to a non-aqueous electrolyte secondary battery having a positive electrode, a negative electrode and non-aqueous electrolyte. The working upper limit potential of the above positive electrode is 4.3 V or more with metal lithium as reference (hereinafter, the potential of the reference metal lithium is sometimes expressed as “vs. Li/Li⁺”). Moreover, the above positive electrode possesses a positive electrode active material layer comprising a positive electrode active material, an electrically-conductive material having a DBP oil absorption of 150 ml/100 g or more and an inorganic phosphoric acid compound with ion conductivity.

By setting the working upper limit of the positive electrode to 4.3 V or more, a potential difference (voltage) between the positive and negative electrodes can be enlarged and a battery of high energy density can be achieved. Furthermore, the resistance of the positive electrode can be reduced by having an electrically conductive material with the above characteristics in the positive electrode active material layer, and a battery having excellent input-output characteristics can be achieved. In addition, through having an inorganic phosphoric acid compound in the positive electrode active material layer, at least one of the following effects is produced.

(1) Inhibiting the oxygenolysis of non-aqueous electrolyte at a high potential.

(2) Moderating the acidity of the non-aqueous electrolyte by consuming (or capturing) the acid (e.g. hydrofluoric acid (HF)) produced by the oxygenolysis of the non-aqueous electrolyte (typically, supporting electrolyte, e.g. LiPF₆).

(3) Forming a stable envelope with low resistance, (e.g. envelope comprising LiF) on the surface of the positive electrode active material through the subsequent charging and discharging (typically, initial charging).

Accordingly, the deterioration of the positive electrode active material (e.g. the dissolution of the metal elements) can be inhibited and a battery of high durability is thereby achieved. Thus, in the non-aqueous electrolyte of such a structure, excellent durability can be achieved in addition to high energy density and high input-output characteristics.

Moreover, in the present specification, “a working upper limit potential of 4.3 V or more with metal lithium as reference” refers to a region whose SOC (state of charge) is in a range of 0˜100% and oxidation-reduction potential (working upper limit potential) of the positive electrode active material is 4.3 V or more (vs. Li/Li⁺). The so-called “SOC” herein refers to the charging state of the battery with the voltage range commonly used by the battery as reference, i.e., the charging state of the battery with the normal capacity measured when the voltage between terminals of the positive and negative electrodes (open circuit voltage; OCV) is within the range from a upper limit voltage (e.g. 4.9 V) to a lower limit voltage (e.g. 3.5 V) as reference. In addition, “DBP oil absorption” in the present specification refers to a value measured according to JIS K6217-4(2008) using DBP (dibutyl phthalate) as a reagent fluid.

The above inorganic phosphoric acid compound may also comprise at least one of an alkali metal element and an element in the group 2 of the periodic table (alkaline earth metal element). Furthermore, the inorganic phosphoric acid compound may also comprise at least one phosphate and pyrophosphate. For example, a phosphate of at least one of an alkali metal element and an element in the group 2 can be exemplified. More specifically, one or more of Li₃PO₄, LiPON, Na₃PO₄ and Mg₃(PO₄)₂ may be comprised. The above inorganic phosphoric acid compound can be particle-like and the particle has an average particle diameter within a range of 1 μm or more and 10 μm or less. Accordingly, the particles of the inorganic phosphoric acid compound can be fairly configured in the gaps of the positive electrode active material for inhibiting the dissolution of metal element from the positive electrode active material at a high level.

The proportion of the above inorganic phosphoric acid compound can be 0.1 part by mass or more and 5 parts by mass or less, based on 100 parts by mass of the positive electrode active material. Generally, the inorganic phosphoric acid compound has an extremely low electrical conductivity. Thus, the concentration of acid in the non-aqueous electrolyte can be fairly moderated and the resistance of the positive electrode can be more reduced through inhibiting the proportion of the inorganic phosphoric acid compound to a necessarily minimum limit. Therefore, the effects of present invention can be produced at a higher level.

Alternatively, the proportion of the above electrically-conductive material can be 1 part by mass or more and 10 parts by mass or less of the entire positive electrode active material layer. Through setting the proportion of the electrically-conductive material within the above range, both excellent input-output characteristics and high energy density can be achieved. Therefore, the effects of present invention can be produced at a higher level.

The above positive electrode active material, for instance, can comprise a lithium-nickel-manganese composite oxide with a spinel structure, wherein one or more elements selected from the group consisting of Ti, V, Cr, Fe, Co, Cu, Zn, AL and W can also be doped. Thus, both density and durability can be guaranteed at a high level.

As stated above, high initial characteristics and durability can be achieved by the non-aqueous electrolyte secondary battery (e.g. lithium-ion secondary battery) disclosed herein. For example, it can be a high energy, density battery whose capacity can hardly reduce even bearing a long-term, high-rate repetitive charging and discharging. Thus, the feature can be efficiently utilized as a vehicle-mounted motor driven power supply (driving power supply) for a plug-in hybrid vehicle, hybrid vehicle and electric vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a longitudinal sectional view illustratively showing a non-aqueous electrolyte secondary battery of the embodiment;

FIG. 2 is a diagram showing a structure of wound electrode body of the embodiment; and

FIG. 3 is a diagram showing the relationship between the initial resistance and the capacity retention rate after a high-temperature durability experiment.

### DETAILED DESCRIPTION OF EMBODIMENTS

A preferred embodiment of the present invention is illustrated as follows. Furthermore, the items indispensable for implementing the present invention (e.g. common manufacturing process of the battery which fails to endow characteristics for the invention) other than those (e.g. structure, of the positive electrode) mentioned in the specification can be grasped as the designation items for those skilled in the art based on the previous technique of the present field. The present invention can be implemented based on the disclosure of the present specification and the technical common knowledge in the art.

The non-aqueous electrolyte secondary battery disclosed herein comprises a positive electrode, a negative electrode and a non-aqueous electrolyte. The structural elements are illustrated sequentially as follows.

### (Positive Electrode)

The positive electrode of the non-aqueous electrolyte secondary battery disclosed herein includes a positive electrode active material layer comprising a positive electrode active material, an electrically-conductive material and an inorganic phosphoric acid compound. The positive electrode is typically the form of the positive electrode active material layer of the above components attached to a positive electrode current collector. As the positive electrode current collector, an electrically-conductive component formed from metals (e.g. aluminum, nickel, titanium, stainless steel, etc.) of good electrical conductivity can be fairly used.

The positive electrode of the non-aqueous electrolyte secondary battery disclosed herein has a working upper limit potential of 4.3 V or more (preferably 4.5 V or more, more preferably 4.6 V or more and further preferably 4.7 V or more) within the range of SOC 0˜100% with metal lithium as reference. Normally, the highest working potential within SOC 0˜100% is when SOC is 100%, the working upper limit potential (e.g. whether it is 4.3 V or more) of the positive electrode can be determined via the working potential of the positive electrode under SOC 100% (i.e. fully-charged state). Moreover, the technique disclosed herein can typically be applied to the non-aqueous electrolyte secondary battery whose working upper limit potential of the positive electrode is 7.0 V or less (e.g. 6.0 V or less, 5.5 V or less) in SOC 0˜100% with metal lithium as reference.

An electrode displaying such a working upper limit potential can be achieved by utilizing a positive electrode active material whose maximum working, potential in the range of SOC 0˜100% is 4.3 V or more (vs. Li/Li⁺), wherein, the positive electrode active material, whose working potential in SOC 100% is 4.3 V or more, preferably 4.5 V or more, more preferably 4.6 V or more, and further 4.7 V or more with metal lithium as reference, is preferably utilized.

The working potential of the positive electrode active material within the range of SOC 0˜100% can be measured as follows: firstly, preparing a working electrode (WE) including the positive electrode active material as a test object, configuring a three-electrode type cell battery by using the working electrode, metal lithium as, a counter electrode (CE), metal lithium as reference electrode (RE) and the non-aqueous electrolyte; then, adjusting the SOC of the three-electrode type cell battery from 0% to 100% at an interval of 5% based on a theoretical capacity of the three-electrode type cell battery, wherein the adjustment of SOC can be carried out by performing a charging treatment between WE and CE, for example, using a common charging-discharging apparatus and a potentiostat. And, the potential between WE and RE of the three-electrode cell battery which has been adjusted to each SOC state can be measured and the potential can be determined as the working potential (vs. Li/Li⁺) of the positive electrode active material in SOC state.

As a positive electrode active material capable of fairly achieving such a high potential, lithium-manganese composite oxide with a spinel structure can be cited as an example. As a preferable manner therein, a lithium-nickel-manganese composite oxide represented by the following general formula (I): Liₓ(Ni_{y}Mn_{2-y-z}M_{z})O₄₊ₐA_{q} (I) can be listed.

Herein, M in the general formula (I) can be, except Ni and Mn, any transition metal element or typical metal element (e.g. one or more of Ti, V, Cr, Fe, Co, Cu, Zn, Al, W). It can also be a semi-metal element (e.g. one or more of B, Si and Ge) and a non-metal element. On the basis of the research and discussion of the inventor, by doping the dissimilar elements, for example, a high structural stability in a high-temperature environment can be achieved. In a preferred embodiment, M comprises Ti and/or Fe. Thus, thermal-stability can be improved and higher durability (e.g. high-temperature recycling characteristic) can be achieved. Besides, in formula (I), x is 0.8≦x≦12; y is 0<y; z is 0≦z; y+z<2 (typically, y+z≦1); α is a value satisfying the charge neutral condition in the case of −0.2≦α≦0.2 and q is 0≦q≦1. Moreover, A can be F or Cl in the case of 0≦q≦1 and q>0. In a preferred embodiment, 0.2≦y≦1.0 (more preferably 0.4≦y≦0.6, e.g., 0.45≦y≦0.55). Accordingly, the effects of the invention can be produced at a higher level. In another preferred embodiment, 0≦z<1.0 (e.g. 0≦z≦0.3, preferably 0.05≦z≦0.2). Accordingly, the effects of the invention can be produced at a higher level.

As specific examples of the lithium-nickel-manganese oxide represented by the above general formula (I), LiNi_{0.5}Mn_{1.5}O₄, LiNi_{0.5}Mn_{1.45}Ti_{0.05}O₄, LiNi_{0.45}Fe_{0.05}Mn_{1.5}O₄, LiNi_{0.45}Fe_{0.05}Mn_{1.45}Ti_{0.05}O₄, LiNi_{0.475}Fe_{0.025}Mn_{1.475}Ti_{0.025}O₄, etc., can be listed.

Generally, in case that a constitutional component of the positive electrode active material comprises a transition metal element (particularly, manganese), in a high potential state, the transition metal element may possibly dissolve. Besides, the acid (such as hydrofluoric acid) produced due to the decomposition of the non-aqueous electrolyte (e.g. supporting electrolyte) may accelerate the dissolution of the above transition metal element. However, according to the technique disclosed herein, through moderating the acidity of the non-aqueous electrolyte by the effect of comprising an inorganic phosphoric acid compound, the dissolution of the transition metal element can be fairly inhibited. Hence, a non-aqueous electrolyte secondary battery with both high energy density and high durability can be achieved.

The characteristic of the positive electrode active material is not specifically defined, but it is typically particle-like or powder-like. The average particle diameter of the particle-like positive electrode active material may be 20μm or less (typically 1˜20 μm, such as 5˜15 μm). Besides, the specific surface area of the positive electrode active material is generally suitable as approximate 0.1˜30 m²/g, typically preferably a specific surface area of 0.2˜10 m²/g, e.g. approximate 0.5˜3 m²/g can be used. Furthermore, the so-called “average particle diameter” in the present specification refers to a particle diameter (D₅₀, also referred to as median diameter) that is equivalent to a cumulative frequency of 50% by volume from a side of small particle diameter in a particle size distribution based on the volume measured—by an ordinary laser diffraction—light scattering method. Moreover, the so-called “specific surface area” in the present specification refers to a surface area (BET specific surface area) analyzed with a BET method (e.g. BET single point method) using an absorption amount measured with a gas absorption method (fixed capacity absorption method) with nitrogen (N₂).

Such a lithium manganese composite oxide with a spinel structure (such as lithium-nickel-manganese composite oxide) is preferably comprised, in all of the used positive electrode active material, in a proportion of 50% by mass or more (e.g. 80˜100% by mass), and a positive electrode active material essentially composed of a lithium manganese composite oxide with a spinel structure is more preferably. Alternatively, within a limitation of not notably decreasing the effects of the invention, some other positive electrode active materials can also be contained other than the above lithium manganese composite oxide with a spinel structure. As a typical example of such other positive electrode active materials, an olivine-type lithium transition metal composite oxide can be listed; and more specifically, LiMnPO₄, LiFePO₄, LiMnPO₄F, Li₂FeSiO₄ can be listed.

The electrically-conductive material comprised in the positive electrode of the non-aqueous electrolyte disclosed herein has a DBP (dibutyl phthalate) oil absorption of 150 mL/100 g or more (typically 160 mL/100 g or more, e.g. 170 mL/100 g or more, particularly 210 mL/100 g or more). The electrically-conductive material satisfying the above requirement has an excellent affinity to the non-aqueous solvent and binder. Thus, the resistance of the positive electrode can be inhibited to be lower and the improvement of for example the input-output characteristics can be achieved as well.

In addition, if an electrically-conductive material having high DBP oil absorption is generally used, the decomposition of the non-aqueous electrolyte (e.g. supporting electrolyte) in the high potential state is promoted, and hence a large amount of acid is produced. Thus, the deterioration of the positive electrode active material may accelerate. Nevertheless, according to the technique disclosed herein, the acidity of the non-aqueous electrolyte can be moderated with an inorganic phosphoric acid compound and a battery having low resistance and high durability can be achieved. The upper limit value of the DBP oil absorption is not particularly restricted, typically 500 mL/100 g or less, e.g. 300 ml/100 g, and it can be set to 250 mL/100 g or less specifically. Therefore, a higher energy density can be achieved.

As such an electrically-conductive material, one or more of the various known materials which can be used as the electrically-conductive material of the non-aqueous electrolyte secondary battery can be used. As a preferred example, various carbon blacks (acetylene black, ketjen black, furnace black, channel black, lamp black, thermal cracking carbon black), activated carbon, graphite, carbon fiber and the like can be listed.

The DBP oil absorption of the electrically-conductive material, for instance, can be adjusted via controlling the physical-chemical characteristics (e.g. average particle diameter, specific surface area, primary structural diameter, etc.). The characteristic of the electrically-conductive material is not particularly defined as long as it is within the range of the above DBP oil absorption. However, generally, the smaller the particle diameter the primary particle has, the bigger the specific area is, the contact surface with the positive electrode active material can be increased. Thus, it is beneficial for forming a suitable electrically-conductive path (electrically-conductive passage) within the positive electrode active material layer. On the other hand, the electrically-conductive material with a large specific surface area has a tendency of increased volume. Thus, there is a concern about a declination of the energy density and extreme enhancement of the reactivity of the non-aqueous electrolyte. Based on these reasons, the average particle diameter of the primary particle forming the carbon black is preferably within a range of 1˜200 nm (typically 10˜100 nm, e.g. 30˜50 nm), the specific surface area is preferably within a range of 25˜1000 m²/g (typically 50˜500 m²/g, e.g. 50˜200 m²/g, preferably 50˜100 m²/g) and the volume density is preferably within a range of 0.01˜0.5 g/cm³, (typically 0.05˜0.3 g/cm³, e.g. 0.05˜0.2 g/cm³). Moreover, the above “average particle diameter of the primary particle” can be an average calculation value of the particle diameters obtained by observing at least 30 (e.g. 30˜100) primary particles using an electron microscope (any one of scanning or transmission type can be used, preferably the transmission electron microscope).

Further, the electrically-conductive material preferably has a chain or a string structure formed by connecting the primary particles in a certain degree. The connection of the primary particles can also be called a structure, and the development degree thereof can be determined such as by the observation with electron microscope. The electrically-conductive material with a structure formed by connecting the primary particles can endow excellent electrical conductivity to the positive electrode active material in a small usage amount. On the other hand, the structure is easily to be wound and curled, hence is difficult to be uniformly configured. Based on the above reasons, the primary structural diameter (also called as aggregate particle diameter) of the electrically-conductive material is preferably within a range of 100˜1000 nm and more preferably within a range of 400˜1000 nm.

In a preferred embodiment disclosed herein, an electrically-conductive material satisfying one or more of the above preferable characteristics (an average particle diameter of the primary particle, a specific surface area, a volume density and the development degree of the structure), in addition to the above DBP oil absorption, is used. Carbon blacks such as acetylene black and ketjen black can be listed as examples of such an electrically-conductive material.

As the inorganic phosphoric acid compound comprised in the positive electrode of the non-aqueous electrolyte disclosed herein, it may not be specifically restricted to us an inorganic phosphoric acid compound (e.g., phosphate, pyrophosphate) having ion conductivity. In a preferred embodiment, the inorganic phosphoric acid compound comprises an alkali metal element and/or an element in the group 2 (alkaline earth group metal element). Furthermore, in another preferred embodiment, the above inorganic phosphoric acid compound comprises a phosphate and/or pyrophosphate. As a preferred example, a known inorganic solid electrolyte material which can function as an electrolyte of an all-solid battery can be listed. Specifically, in the case of using lithium salt as the supporting electrolyte (i.e. charge carrier, ion is Li⁺), phosphoric acid series lithium ion conductor such as Li₃PO₄ and LiPON (lithium phosphorus oxy-nitride), etc.; Nasicon type lithium ion conductor such as Li_{1.5}Al_{0.5}Ge_{1.5}(PO₄)₃, etc.; perovskite-type lithium ion conductor; thio-LISICON type lithium ion conductor, etc., can be used, wherein, Li₃PO₄ can be well utilized. Although an example that the charge carrier ion is Li⁺ is shown above, it can also be other cations (typically, alkali metal ions (ions of the group 1), e.g. Na⁺, K⁺ and alkaline earth metal ions (ions of the group 2), e.g. Mg²⁺, Ca²⁺). That is, the “inorganic phosphoric acid compound possessing the ion conductivity” disclosed herein can be grasped as “phosphate (phosphoric acid compound) of an alkali metal (the element in the group 1) and/or an alkali earth metal (the element in group 2)”. As specific examples, Li₃PO₄, Na₃PO₄, K₃PO₄, Mg₃(PO₄)₂ and Ca₃(PO₄)₂, etc., can be listed.

The characteristic of the inorganic phosphoric acid compound is not specifically restricted, typically particle-like or powder-like. The average particle diameter of the particle-like inorganic phosphoric acid compound can be 20 μm or less (typically 1˜20 μm, e.g., 5˜7 μm). Accordingly, the particles of the inorganic phosphoric acid compound can be fairly filled in the gaps of the positive electrode active material and, also consume (capture) the “acid” existing near the positive electrode active material. Moreover, a suitable electrically-conductive path (electrically-conductive passage) can also be formed within the positive electrode (typically, positive electrode active material layer) so as to reduce the internal electrical resistance.

In addition to the above positive electrode active material, electrically-conductive material and inorganic phosphoric acid compound, the positive electrode active material layer can comprise one or more of the materials used as the constitutional components of the positive electrode active material layer in a common non-aqueous electrolyte secondary battery according to the needs. As a typical example of such materials, a binder can be listed. As a binder, for instance, a vinyl halide resin such as polyvinylidene fluoride (PVdF) and a polyalkylene oxide such as polyethylene oxide (PEO) can be fairly used. Furthermore, various additives (e.g. inorganic compound, dispersants, thickener which produce gas when being overcharged) can be further contained with a restriction of not notably damaging the effects of the present invention.

The proportion of the positive electrode active material in the positive electrode active material layer is approximately suitably 50% by mass or more (typically 50˜95% by mass), and generally preferably approximately 80˜95% by mass, which hence can achieve a high energy density. The proportion of the electrically-conductive material in the positive electrode active material layer can be set to 1˜20% by mass, generally preferably approximately 1˜10% by mass (e.g. 5˜10% by mass). By setting the proportion of the electrically-conductive material to 1% by mass or more, a positive electrode active material layer of excellent electrical conductivity can be achieved. Thus, the internal electrical resistance can be reduced and high input-output characteristics can be achieved. Moreover, by setting the proportion of the electrically-conductive material to 20 parts by mass or less (preferably 10% by mass or less), the input-output characteristics and energy density can both be achieved at a higher level. The proportion of the inorganic phosphoric acid compound in the positive electrode active material layer can be set to 0.1˜5% by mass, generally preferably approximately 0.5˜1% by mass (e.g. 0.6˜0.9% by mass). By setting the proportion of the inorganic phosphoric acid compound to 0.1% by mass or more (typically 0.5% by mass or more, e.g. 0.6% by mass or more), the effects of the invention can be sufficiently produced (i.e. improvement of the durability of the battery). Further, by setting it to 5% by mass or less (typically 1% by mass or less, e.g. 0.9% by mass or less), the electrical resistance within the positive electrode active material layer can be more reduced. In the case of using a binder, the proportion of the binder in the whole positive electrode active material layer can be set to 0.5˜10% by mass, generally preferably approximately 1˜5% by mass. Thus, the mechanical strength of the positive electrode active material layer (shape retention) can be ensured and good durability (e.g. high-temperature cycle characteristic) can be achieved.

Further, in a technique disclosed herein, it is appropriate to set the inorganic phosphoric acid compound comprised in the positive electrode to 0.1˜5 parts by mass with respect to 100 parts by mass of the positive electrode active material, generally preferably 0.5˜2 parts by mass (e.g. 0.5˜1 part by mass). The acidity of the non-aqueous electrolyte surrounding the positive electrode active material can be fairly moderated through setting the addition amount of the, inorganic phosphoric acid compound to 0.1 part by mass or more with respect to 100 parts by mass of the positive electrode active material (preferably, 0.5 part by mass or more, and more preferably 0.7 part by mass or more). In addition, a good electrical conductivity can be imposed to the positive electrode and the internal electrical resistance can be more reduced through inhibiting the addition amount of the inorganic phosphoric acid compound having low electrical conductivity to 5 parts by mass or less (preferably 1 part by mass or less, e.g.

0.9 part by mass or less).

### (Negative Electrode)

The negative electrode of the non-aqueous electrolyte secondary battery disclosed herein, is typically in a form where the negative electrode active material layer comprising the negative electrode active material is attached to a negative electrode current collector. As the negative electrode current collector, an electrically-conductive material made from metals having good electrical conductivity (e.g. copper, nickel, titanium, stainless steel, and the like).

As the negative electrode active material, it may not be specifically restricted as utilizing one or more of the materials which are always used as the negative electrode active material of the non-aqueous electrolyte secondary battery. Specific examples can be listed, such as a carbon material such as graphite, hard carbon (non-graphitizable carbon), soft carbon (graphitizable carbon), a metal oxide material such as silicon oxide, titanium oxide, vanadium oxide and lithium titanium composite oxide (LTO), and a metal nitride material such as lithium nitride, lithium-cobalt composite nitride, lithium-nickel composite nitride and the like, wherein, a graphite series carbon material (a carbon material comprising a graphite of 50% by mass or more of all the negative electrode active materials used) is preferably used.

In addition to the above negative electrode active materials, the negative electrode active material layer can comprise one or more of the materials used as the constitutional components of the negative electrode active material layer in the common non-aqueous electrolyte secondary battery according to the needs. As a typical example of such material, a binder can be listed. As the binder, styrene-butadience rubber (SBR), poly vinylidene fluoride (PVdF), polytetrafluoroethylene (PTFE), carboxymethylcellulose (CMC) and methyl cellulose (MC) etc. can be fairly utilized. Furthermore, various additives (e.g. dispersants, thickener and conductive material, etc.) can also be further contained with the restriction of not notably damaging the effects of the present invention.

The negative electrode active material appropriately covers a proportion of approximately 50% by mass or more in the whole negative electrode active material layer, preferably 90˜99% by mass (e.g. 95˜99% by mass). In the case of using a binder, the proportion of the binder in the negative electrode active material layer can be set to approximately 1˜10% by mass, normally appropriately 1˜5% by mass.

### (Non-Aqueous Electrolyte)

The non-aqueous electrolyte of the non-aqueous electrolyte secondary battery disclosed herein is in a liquid form at room temperature (e.g. 25° C.), preferably always in a liquid form during the used temperature range (e.g. −20° C.˜60° C.). The non-aqueous electrolyte is typically one having a supporting electrolyte (e.g. lithium salts, sodium salts, magnesium salts, etc.; lithium salt in a lithium ion secondary battery) dissolved or dispersed in a non-aqueous solvent. Alternatively, it can also be a solid-like (typically, the so-called gelatinous) substance formed by having a polymer added into a liquid non-aqueous electrolyte. As the supporting electrolyte, the one the same as that in the non-aqueous electrolyte secondary battery can be suitably selected. For instance, in the case of setting the charging carrier ion to lithium ion (Li⁺), lithium salts such as LiPF₆, LiBF₄, LiClO₄, LiAsF₆, Li(CF₃SO₂)₂N and LiCF₃SO₃ etc. can be utilized, wherein LiPF₆ is preferably used. The concentration of the above supporting electrolyte is preferably adjusted to within a range of 0.7˜1.3 mol/L.

As a non-aqueous solvent, organic solvents such as carbonates, ethers, esters, nitriles, sulfones, lactones for a normal non-aqueous electrolyte secondary battery may be used without particular restriction. As specific examples, ethylene carbonate (EC), propylene carbonate (PC), diethyl carbonate (DEC), dimethyl carbonate (DMC), ethyl methyl carbonate (EMC) can be listed.

In a preferred embodiment disclosed herein, the above non-aqueous electrolyte comprises a fluorine-containing non-aqueous solvent, which, for example, can be a known fluoride of an organic solvent (an organic compound) that can be used as the non-aqueous solvent of the non-aqueous electrolyte secondary battery. In other words, it can be an organic solvent of a chemical structure in which at least one hydrogen atom is replaced by a fluorine atom among the organic solvent free of fluorine (such as the above carbonates, ethers, esters, nitriles, sulfones, and lactones, etc.) as a constitutional element. Wherein, one or more types of fluorinated carbonate are preferably contained. Thus, the oxidation potential of the non-aqueous electrolyte can be improved so that the oxygenolysis of the non-aqueous, electrolyte hardly occurs even in a high potential state. Namely, excellent oxidation resistance can be achieved. Examples of the fluorinated carbonate may be a fluorinated cyclic carbonate such as monofluoroethylene carbonate (MFEC) and difluoroethylene carbonate (DFEC), and a fluorinated chain carbonate such as fluoromethyl methyl carbonate, difluoromethyl methyl carbonate, trifluoromethyl methyl carbonate, fluoromethyl difluoromethyl carbonate, and trifluorinated dimethyl carbonate (TFDMC).

In a case of setting the total ingredients of the non-aqueous electrolyte except the supporting electrolyte to 100% by mass, such fluorine-containing non-aqueous solvent is preferably contained in a proportion of 1% by mass or more (typically 5˜100% by mass, e.g. 30˜100% by mass, preferably 50˜100% by mass) or in a proportion of 100% by mass (typically, 99% by mass-or more) of the ingredients except the above supporting electrolyte. Alternatively, it can comprise both the fluorine-containing non-aqueous solvent and a non-aqueous solvent free of fluorine as a constitutional element. In such case, the proportion of the non-aqueous solvent free of fluorine atom is, for example, preferably 70% by mass or less of the ingredients of the non-aqueous electrolyte except the supporting electrolyte, more preferably 60% by mass or less (e.g. 50% by mass).

In a preferred embodiment disclosed herein, the fluorine-containing non-aqueous solvent comprises at least one type of fluorinated chain carbonate and at least one type of fluorinated cyclic carbonate. In the non-aqueous electrolyte of such a constitution, fluorinated chain carbonate (preferably a straight-chain fluorinated carbonate) can function to keep the non-aqueous electrolyte in a liquid form at room temperature (e.g. 25° C.) or to reduce the viscosity of non-aqueous electrolyte.

Further, within a restriction of not notably damaging the effects of the present invention, the non-aqueous electrolyte can further suitably include various additives (envelope-forming agents such as lithium bis(oxalate)borate (LiBOB), vinylene carbonate (VC), vinyl ethylene carbonate (VEC), fluoro-ethylene carbonate (FEC) and the like and a compound which may produce gas upon overcharge such as biphenyl (BP), cyclohexylbenzene (CHB), etc.

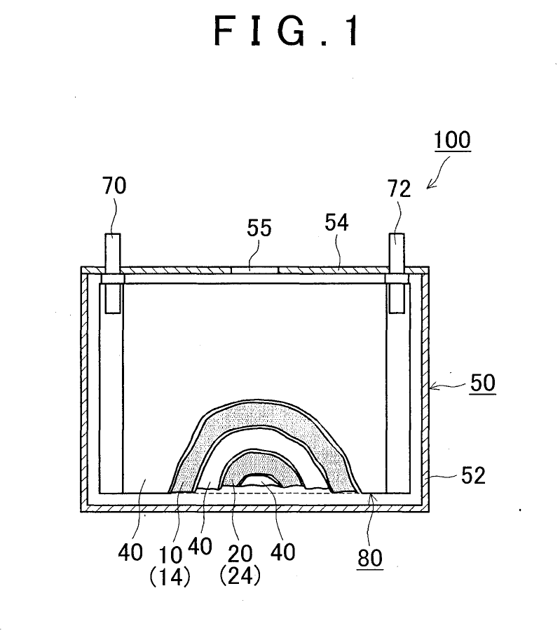

Though it is not intentionally particularly restricted, as a schematic structure of the non-aqueous electrolyte secondary battery involved in an embodiment of the present invention, the present invention is explained in details with the non-aqueous electrolyte secondary battery (single battery) schematically represented by FIG. 1. In the following figures, same numerals denote the components or parts of the same functions, and repetitive illustrations are sometimes omitted or simplified. The dimensional relationship (length, width, thickness) in these figures does not certainly reflect the real one.

The non-aqueous electrolyte secondary battery 100 shown in FIG. 1 has the following structure: an electrode body (wound electrode body 80) formed by flatly winding a positive electrode plate 10 and a negative electrode plate 20 separated by a separator sheet 40 as well as the non-aqueous electrolyte not shown are housed in a flat case-shaped battery housing 50.

The battery housing 50 comprises a flat rectangular shape (case shape) battery housing body 52 with an open upper end and a cover body 54 plugging its opening. The material of the battery housing 50 can be preferably a light metal (e.g. aluminum, aluminum alloy). On the upper surface of the battery housing 50 (i.e. cover body 54), a positive electrode terminal 70 for external connection configured to be electrically connected to the positive electrode of the wound electrode body 80 and a negative electrode terminal 72 configured to be electrically connected to the negative electrode of the wound electrode body 80. The same as the battery housing of the previous non-aqueous electrolyte battery, the cover body 54 also possesses a safety valve 55 for venting the gas produced inside the battery housing 50 to the outside of the housing 50.

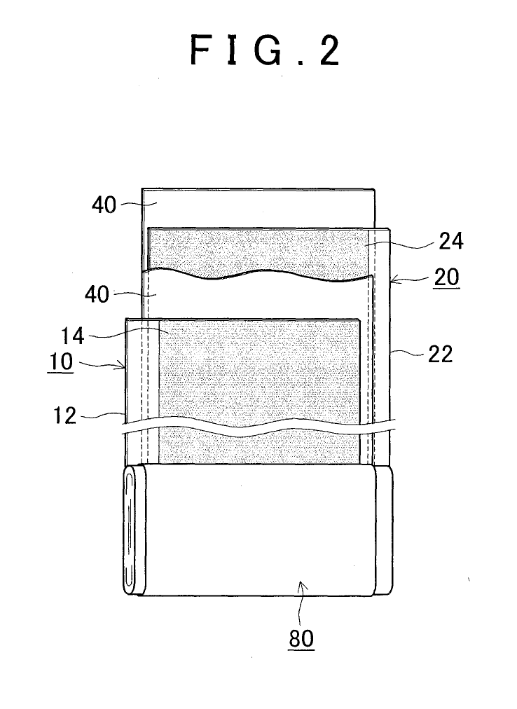

Inside the battery housing 50, the flat-shaped wound electrode body 80 and a non-aqueous electrolyte not shown are housed together. FIG. 2 is a schematic diagram showing the structure of the wound electrode body 80 as shown in FIG. 1. The wound electrode body 80 of the present embodiment possesses a long-sheet positive electrode (positive electrode plate 10) and a long-sheet negative electrode (negative electrode plate 20). The positive electrode plate 10 comprises a long-strip positive electrode current collector 12 and a positive electrode active material layer 14 formed along a longitudinal direction on the surface (typically, two surfaces) of at least one part thereof. The negative electrode plate 20 comprises a long-strip negative electrode current collector 22 and a negative electrode active material layer 24 formed along a longitudinal direction on the surface (typically, two surfaces) of at least one part thereof. Moreover, between the positive electrode active material layer 14 and the negative electrode active material layer 24 an insulation layer for avoiding their direct contact is disposed. Herein, two long-sheet separators 40 are employed as the above insulation layer, which can be porous pieces and nonwovens constituted of resin such as polyethylene (PE), polypropylene (PP), polyester, cellulose and polyamide, etc.

In a width direction stipulated to be from one end to the other of the winding shaft direction of the wound electrode body 80, a winding core portion is formed in the central part, and it is formed by overlapping and closely laminating the positive electrode active material layer 14 formed on the surface of the positive electrode current collector 12 and the negative electrode material active material layer 24 formed on the negative electrode current collector 22. Besides, at the two ends of the winding shaft direction of the wound electrode body 80, the positive electrode active material layer non-forming portion of the positive electrode plate 10 and the negative electrode active material layer non-forming portion of the negative electrode plate 20 protrude outward respectively from the winding core portion. In addition, a positive electrode current collector board is disposed on the protruding portion of the positive electrode side and a negative electrode current collector board is disposed on the protruding portion of the negative electrode side, which are electrically connected respectively to a positive electrode terminal 70 (FIG. 1) and a negative electrode terminal 72 (FIG. 1).

A non-aqueous electrolyte secondary battery 100 of such a structure, for instance, can be constructed by housing the wound electrode body 80 from the opening portion of the battery housing body 52 into its inside, injecting the non-aqueous electrolyte from an injection hole (not shown) set in the cover body 54 after installing the cover body 54 at the opening portion of the housing body 52, followed by sealing the injection hole via welding, and the like.

The non-aqueous electrolyte secondary battery disclosed herein (typically, lithium ion secondary battery), characterized in a large battery capacity, excellent input-output characteristics and high durability, can be used in various purposes. Therefore, such features can be fairly used for the uses requiring high energy density, high input-output density and high durability. For the function, examples such as the vehicle-mounted motor driven power supply (driving power supply) for the plug-in hybrid vehicle, hybrid vehicle, and electric vehicle, and the like, can be listed. Moreover, the non-aqueous electrolyte secondary battery can be used in the form of a battery set formed by connecting a plurality of batteries in serial and/or in parallel.

Hereinafter, some examples related to the present invention are explained; nevertheless, the present invention is not intended to be restricted with the following examples.

### (Manufacture of the Positive Electrode (Example 1˜Example 5))

As for the positive electrode active material, NiMn spinel (LiNi_{0.45}Fe_{0.05}Mn_{1.45}Ti_{0.05}O₄) having an average particle diameter of 13.3 μm is prepared, and 5 types of acetylene black having the DBP oil absorption of 125˜220 ml/g are prepared for the electrically-conductive material. In addition, weighing the above NiMn spinel as the positive electrode active material, acetylene black (AB) having the DBP oil absorption shown in Table 1, and poly(vinylidene fluoride) (PVdF) as the binder to form a mass ratio of LiNi_{0.5}Mn_{1.5}O₄:AB:PVdF=89:8:3, which are then mixed with N-methyl-2-pyrrolidone (NMP) to prepare a composition slurry. The positive electrode active material layer is formed by coating the composition on an aluminum foil having a thickness of 15 μm (positive electrode current collector) and drying. And thus a positive electrode (Example 1˜Example 5) comprising the positive electrode active material layer on the surface of the positive electrode collector is obtained.

### (Manufacture of the Positive Electrode (Example 6˜Example 10))

Herein, except the positive electrode active material and the electrically-conductive material, the commercially available Li₃PO₄ having an average particle diameter of 6.1 μm is prepared as the inorganic phosphoric acid compound. In addition, firstly, the above NiMn spinel as the positive electrode active material and Li₃PO₄ as the inorganic phosphoric acid compound are mixed with a mass ratio of 100:1. Then, weighing the mixture, acetylene black (AB) as the electrically-conductive material, and poly (vinylidene fluoride) (PVdF) as binder to form a mass ratio of (LiNi_{0.5}Mn_{1.5}O₄+Li₃PO₄):AB:PVdF=89:8:3, are mixed respectively with NMP to form a composition slurry. Further, the positive electrode active material layer is formed by coating the composition on an aluminum foil having a thickness of 15 μm (positive electrode current collector) and drying. Thus, a positive electrode (Example 6˜Example 10) possessing the positive electrode active material layer on the surface of the positive electrode current collector is obtained.

### (Manufacture of the Negative Electrode)

Weighing the graphite (C) as the negative electrode active material, carboxymethyl cellulose (CMC) as the binder, and styrene-butadiene rubber (SBR) to form a mass ratio of C:CMC:SBR=98:1:1, which are then mixed with an ion exchange water to form a composition slurry. The negative electrode active material layer is formed by coating the composition on the copper foil having a thickness of 10 μm (negative electrode current collector) and drying. Thus, the negative electrode possessing the negative electrode active material layer on the surface of the negative electrode current collector is obtained.

### (Construction of the Non-Aqueous Electrolyte Secondary Battery (Example 1˜Example 10)

An electrode body is manufactured by laminating the above manufactured positive electrode and negative electrode which are separated with a separator. For the separator, a porous thin film of three-layered structure having a thickness of 20 μm composed of polyethylene (PE)/polypropylene (PP)/polyethylene (PE). Moreover, for the non-aqueous electrolyte, a non-aqueous electrolyte formed in a manner of dissolving LiPF₆ as the supporting electrolyte into a mixed solvent comprising monofluoroethylene carbonate (MFEC) as a cyclic carbonate and fluoromethyl difluoro methyl carbonate and trifluorinated dimethyl carbonate (TFDMC) as a chain carbonate in a volume ratio of 1:1 to achieve a concentration of 1.0 mol/L. Then, the lithium ion secondary battery is constructed by housing the above manufactured electrode body and the non-aqueous electrolyte into the layer-laminated battery housing, and sealing (Example 1˜Example 10).

### (Adjustment Processing)

Performing the following charging and discharging operations (1) and (2) on the above constructed battery (Example 1˜Example 10) for three cycles at the temperature environment of 25° C. to implement the adjustment processing.

(1) Performing a constant-current charging at a rate of ⅓ C until the positive electrode potential is 4.9 V, discontinuing for 10 minutes.

(2) Performing a constant-current discharging at a rate of ⅓ C until the positive electrode potential is 3.5 V, discontinuing for 10 minutes.

### (Initial Electrical Resistance)

The CC charging on the above adjusted battery (Example 1˜Example 10) is performed at a rate of ⅓ C at a temperature environment of 25° C. to adjust the SOC into 60%. For the battery, the CC discharging at a rate of 1 C, 3 C, 5 C and 10 C is performed respectively, and the voltage variation (the voltage decreasing amount) for 10 seconds is measured from the time point of discharging. The IV resistance (Ω) is calculated by dividing the measured voltage decreasing value (V) with a corresponding current value and the average value thereof is employed as the initial electrical resistance. The result is showed in Table 1.

### (High Temperature Durability Experiment)

The high temperature durability of the battery is evaluated by placing the battery whose initial performance is measured (Example 1˜Example 10) in a thermostat at a temperature of 60° C. for two hours or more and performing the charging and discharging operations (1) and (2) for 200 cycles.

(1) Performing the CC charging at a rate of 2 C until the positive electrode potential is 4.9 V, discontinuing for 10 minutes.

(2) Performing the CC discharging at a rate of 2 C until the positive electrode potential is 3.5 V, discontinuing for 10 minutes.

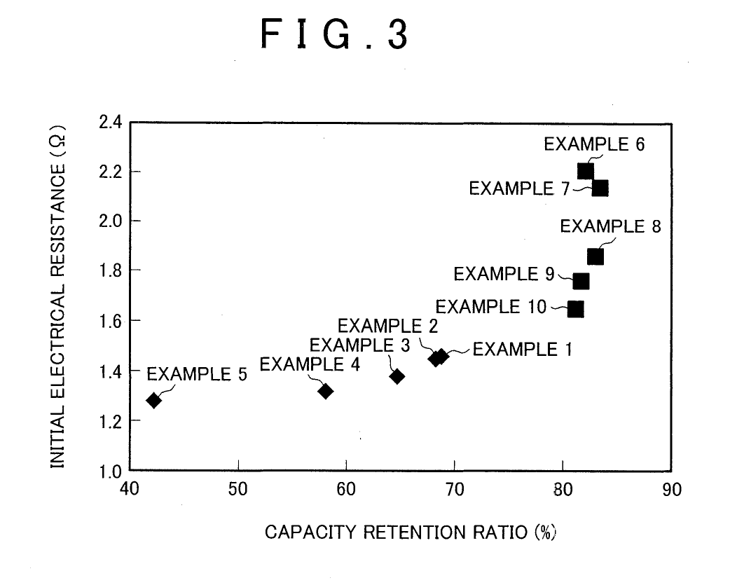

Following the high temperature durability experiment, the capacity retention ratio (%) is calculated by using the CC discharging capacity in the first cycle and the CC discharging capacity in the 200^{th} cycle via the following formula (the CC discharging capacity in the 200^{th} cycle/the CC discharging capacity in the first cycle)×100, and the result is shown in Table 1. In addition, FIG. 3 represents the relationship of the initial electrical resistance and the capacity retention ratio after the high-temperature durability experiment.

TABLE 1

| | Inorganic | | | |
|---|---|---|---|---|
| | phosphoric | Electrically- | Initial | High- |
| | acid | conductive | charac- | temperature |
| | compound | material | teristics | durability |
| | Type | DBP oil | IV electrical | Capacity reten- |
| | (volumn of | absorption | resistance | tion ratio |
| | additon) | (ml/100 g) | (Ω) | (%) |
| Example 1 | None | 125 | 1.46 | 68.8 |
| Example 2 | None | 140 | 1.45 | 68.3 |
| Example 3 | None | 160 | 1.38 | 64.7 |
| Example 4 | None | 200 | 1.32 | 58.1 |
| Example 5 | None | 220 | 1.28 | 42.2 |
| Example 6 | Li₃PO₄ | 125 | 2.21 | 82.1 |
| | (1.0 part | | | |
| | by mass) | | | |
| Example 7 | Li₃PO₄ | 140 | 2.14 | 83.4 |
| | (1.0 part | | | |
| | by mass) | | | |
| Example 8 | Li₃PO₄ | 160 | 1.86 | 83.0 |
| | (1.0 part | | | |
| | by mass) | | | |
| Example 9 | Li₃PO₄ | 200 | 1.76 | 81.7 |
| | (1.0 part | | | |
| | by mass) | | | |
| Example 10 | Li₃PO₄ | 220 | 1.65 | 81.2 |
| | (1.0 part | | | |
| | by mass) | | | |

Firstly, comparing the results of Example 1˜Example 5 which the positive electrode active material layer is free of Li₃PO₄. From Table 1 and FIG. 3, it can be clearly concluded that in Example 1˜Example 5, as the DBP oil absorption of the acetylene black increases, the initial electrical resistance decreases, due to the reason of the use of a acetylene black having a high DBP oil absorption, a good conductive path within the positive electrode active material layer can be formed. However, in Example 1˜Example 5, on the other hand, as the DBP oil absorption of the acetylene black increases, the declination of the high-temperature durability (capacity retention ratio) is verified, due to the reason that as a result of the increasing amount of the non-aqueous electrolyte existing on the surface of acetylene black, the oxygenolysis of the non-aqueous electrolyte is promoted. Consequently, it is deemed that a large amount of acid produced accelerates the deterioration of the positive electrode active material (typically the dissolution of the metal elements) and worsens the high-temperature durability.

Next, comparing the results of Example 6˜Example 10 which, the positive electrode active material layer contains Li₃PO₄. From Table 1 and FIG. 3, it can be clearly concluded that in Example 6˜Example 10, the same as Example 1˜Example 5, as the DBP oil absorption of the acetylene black increases, the initial resistance decreases. Further, a reduction rate of the electrical resistance becomes higher via comprising Li₃PO₄. The reasons are ambiguous, but they are considered to be that (1) by comprising an acetylene black having a high DBP oil absorption, the low electronic conductivity of Li₃PO₄ is moderated, (2) by comprising Li₃PO₄, a stable envelope film with a low electrical resistance, is formed on the surface of the positive electrode active material. In particular, in the case of using an acetylene black having a DBP oil absorption of 160 ml/100 g or more (for example, the DBP oil absorption is 160˜220 mg/100 g), such a notable effect of electrical resistance reduction is verified. As for the high-temperature durability (capacity retention rate), they all present high values due to the effect of comprising Li₃PO₄ and the DBP oil absorption of acetylene black influences slightly. As the reason therefor, it is considered that, for example, even in the case that an increased amount of acid is produced due to the oxygenolysis of a large amount of the non-aqueous electrolyte on the surface of the acetylene black of high DBP oil absorption, through the co-existence of Li₃PO₄, the acid can be consumed (or captured), the deterioration of the positive electrode active material (typically, the dissolution of the metal elements) can be inhibited.

From the aforesaid, it can be concluded that in the non-aqueous electrolyte secondary battery of such a structure disclosed herein, through a positive electrode active material layer comprising an electrically-conductive material having a DBP of 150 ml/100 g or more and an inorganic phosphoric acid compound, a battery of excellent durability and low electrical resistance can be achieved. For instance, the initial electrical resistance can be controlled to 2 Ω or less and the capacity retention rate after the high-temperature cycle can be kept 80% or more. The results exhibit the technical meaning of the present invention.

The above are detailed illustrations of the present invention. However, the above embodiments and examples are only exemplifications. The invention disclosed herein contains cases of various transformations and variations of the above specific examples.

1. A non-aqueous electrolyte secondary battery, comprising:
a positive electrode, the positive electrode comprising a positive electrode active material layer which includes a positive electrode active material, an electrically-conductive material having a DBP oil absorption of 160˜220 ml/100 g, and an inorganic phosphoric acid compound having an ion conductivity, and a working upper limit potential of the positive electrode being 4.5 V or more with metal lithium as reference;
a negative electrode; and
a non-aqueous electrolyte.

2. The non-aqueous electrolyte secondary battery according to claim 1, wherein,
a proportion of the inorganic phosphoric acid compound is 0.1 part by mass or more and 5 parts by mass or less with respect to 100 parts by mass of the positive electrode active material.

3. The non-aqueous electrolyte secondary battery according to claim 1, wherein,
the inorganic phosphoric acid compound is a phosphate of at least one of an alkali metal element and an element in the group 2 of the periodic table.

4. The non-aqueous electrolyte secondary battery according to claim 3, wherein,
the inorganic phosphoric acid compound comprises one or more selected from the group consisting of Li₃PO₄, LiPON, Na₃PO₄ and Mg₃(PO₄)₂.

5. The non-aqueous electrolyte secondary battery according to claim 1, wherein,
the inorganic phosphoric acid compound is a particle, and an average particle diameter of the particle is 1 μm or more and 10 μm or less.

6. The non-aqueous electrolyte second battery according to claim 1, wherein,
a proportion of the electrically-conductive material is 1% by mass or more and 10% by mass or less of a whole positive electrode active material layer.

7. The non-aqueous electrolyte second battery according to claim 1, wherein,
the positive electrode active material comprises a lithium-nickel-manganese composite oxide with a spinel structure.

8. The non-aqueous electrolyte secondary battery according to claim 7, wherein,
in the lithium-nickel-manganese composite oxide, one or more elements selected from the group consisting of Ti, V, Cr, Fe, Co, Cu, Zn, Al and W are doped.
